(19) United States
(12) Patent Application Publication
(10) Pub. No.: US 2021/0078758 A1
(43) Pub. Date: Mar. 18, 2021

(54) LEAK PROOF CONTAINER WITH PUSH LOCK BODY AND ROLLOVER HINGE

(71) Applicant: INTERNATIONAL PAPER COMPANY, Memphis, TN (US)

(72) Inventors: MARK ANTHONY WISECARVER, MORRISTOWN, TN (US); JAMES WILLIAM SLOAN, II, EDGEFIELD, SC (US); KENNETH CALVIN HYATT, SPRINGDALE, AR (US); JADE KIARA HOUSEWIRTH, RICHMOND, VA (US)

(21) Appl. No.: 16/896,940

(22) Filed: Jun. 9, 2020

Related U.S. Application Data
(63) Continuation-in-part of application No. 16/572,809, filed on Sep. 17, 2019.

(51) Int. Cl. B65D 5/42; B65D 5/24; B65D 5/30; B31B 50/26

(52) U.S. Cl. CPC B65D 5/4279; B31B 50/26; B65D 5/301; B65D 5/244

(57) ABSTRACT

A leak proof container and a method of forming the container from a blank. The blank includes a bottom panel, first and second side panels at opposing lateral edges of the blank, and opposing end portions located at opposing longitudinal ends of the blank. Each end portion includes an inner end panel, an outer end panel hingedly connected to the inner end panel at hinge portions, and first and second corner panels, each corner panel forming a gusset between one of the side panels and the inner end panel, each gusset including a notch area for receiving one of the hinge portions. First and second locking tabs are defined in the outer end panel. The outer end panel can be folded over the inner end panel to position the hinge portions in the notch areas, and the locking tabs can be positioned between the gussets and the inner end panel.

### RELATED APPLICATIONS

This application is a continuation-in-part of U.S. patent application Ser. No. 16/572,809, filed Sep. 17, 2019, and entitled “LEAK PROOF CONTAINER WITH PUSH LOCK BODY,” the entire disclosure of which is incorporated herein by reference.

### FIELD OF THE INVENTION

The present disclosure relates to containers or trays formed from a blank of material and, more particularly, to a container that is formed with a leak proof construction for retaining moisture or fluid within the container.

### BACKGROUND OF THE INVENTION

In some applications of containers or trays formed of folded material such as paperboard material, e.g., corrugated paperboard, the container or tray may be configured to receive products having moisture or a fluid content that can leak into a base portion of the container or tray. In a known use of a container, a package containing protein parts of poultry may be supported within the container and the container can prevent leakage of fluids outside of the container.

For example, one known type of container can be formed from a blank of corrugated material wherein a bottom panel and a plurality of side panels may be formed of a unitary construction from a die cut and scored sheet of material. It is also known to provide such a container construction wherein the corners adjacent to the bottom are sealed. In such a container construction, the side panels can be integrally connected to the bottom panel along respective fold lines, and adjacent side panels can be connected by a folded gusset or web that is disposed at each corner to essentially configure the corners as leak proof connections between panels. While such container constructions can facilitate containing and handing of food products, such as in a food processing plant, one known problem that may be associated with leakproof containers is the potential of foreign object contamination. For example, in production processes for corrugated container blanks configurated and used for forming current leakproof containers, there is potential for corrugated trim to remain attached to the container blank. Hence, there remains a possibility that trim debris may release from a container to contaminate the container contents, such as when containers are assembled manually or mechanically and/or when containers are positioned in close relation to each other as trim falls in between stacked containers during manufacturing, wherein the trim can find its way into assembled boxes filled with product.

An additional problem identified in prior containers that incorporate a self-locking design is that the containers can be difficult to lock into an assembled configuration and/or secure assembly of the container may not be maintained if the container is not set up correctly.

### SUMMARY OF THE INVENTION

In accordance with an aspect of the present disclosure, a blank for making a leak proof container is described. The blank comprises a bottom panel having a plurality of peripheral edges. First and second side panels are connected to the bottom panel at opposing lateral peripheral edges and define lower edges of the container. First and second end portions are located at opposing longitudinal ends of the blank. Each end portion includes an inner end panel connected to a longitudinal peripheral edge of the bottom panel, an outer end panel having an inner longitudinal edge connected to a longitudinal edge of the inner end panel at hinge portions, first and second corner panels, each corner panel having an inner longitudinal edge connected to a respective one of the first and second side panels and an inner lateral edge connected to a lateral edge of the inner end panel, and each corner panel including a notch formed in at least one of an outer longitudinal edge and an outer lateral edge of the corner panel. First and second locking tabs are defined in the outer end panel, each locking tab being defined by a lateral tab separation line located longitudinally inward from an outer longitudinal edge of the outer end panel and extending laterally to define a free tab end.

The hinge portions may comprise laterally spaced first and second hinge portions, each hinge portion may be defined by a pair of longitudinally spaced hinge score lines and a pair of laterally spaced hinge separation lines extending longitudinally between the pair of longitudinally spaced hinge score lines.

Each corner panel may include a pair of notches comprising a longitudinal notch and a lateral notch extending along the outer longitudinal edge and the outer lateral edge, respectively, of the corner panel.

The longitudinal and lateral notches may define respective longitudinal and lateral notch dimensions, and the longitudinal and lateral notch dimensions may be greater than a lateral dimension of the hinge portions, measured between the laterally spaced hinge separation lines.

The blank may include a separation line longitudinally aligned with the first and second hinge portions and defining a boundary between the inner and outer end panels.

The corner panels may be formed as square panels, and may include a diagonal fold line dividing each corner panel into first and second triangular gusset panels.

The outer lateral edge of each corner panel may be collinear with a lateral edge of the blank defined by an edge of one of the first and second side panels.

A longitudinal tab separation line may extend longitudinally inward from the outer longitudinal edge of the outer end panel to each of the lateral tab separation lines, wherein the longitudinal tab separation lines may angle laterally inward toward each other extending from the outer longitudinal edge of the outer end panel toward a respective lateral tab separation line, and the free ends of the tabs may be defined at the longitudinal tab separation lines.

A longitudinal dimension of the outer end panel may be substantially less than a longitudinal dimension of the inner end panel.

In accordance with another aspect of the present disclosure, a container is provided including a bottom panel and a plurality of side panels, and a plurality of overlapping end panels defining at least one end portion. The at least one end portion comprises a first locking feature formed integral with at least one end panel and engaged with an additional end panel positioned in overlapping relationship with the at least one end panel to at least partially lock one or more of the end panels in an assembled position at the end portion. The at least one end portion additionally comprises a second locking feature formed integral with the at least one end panel and configured differently from the first locking feature, wherein the second locking feature is engaged with the additional end panel to at least partially lock one or more of the end panels in an assembled position at the end portion.

At least a portion of the first locking feature may be located adjacent to a first longitudinal edge of the at least one end panel, and at least a portion of the second locking feature may be located adjacent to a second longitudinal edge of the at least one end panel, opposite from the first longitudinal edge.

The first locking feature may apply a force to the additional end panel in a first direction to maintain the additional end panel in a position oriented transverse to at least one side panel, and the second locking feature may apply a force to the at least one end panel to resist movement of the at least one end panel in a direction opposite to the first direction.

The plurality of end panels may comprise an inner end panel connected to the bottom panel and an outer end panel connected to the inner end panel and positioned in overlapping relation to the inner end panel.

The first locking feature may comprise a hinge portion connecting the outer end panel to the inner end panel, and the hinge portion may engage a notch area formed in an edge of the additional end panel.

The second locking feature may comprise a locking tab positioned between the additional end panel and the inner end panel.

The additional end panel may comprise a gusset connected to a side panel and positioned between the outer end panel and the inner end panel.

In accordance with another aspect of the present disclosure, a container is provided including a bottom panel defining a bottom of the container and having a plurality of peripheral edges. First and second side panels are connected to the bottom panel at opposing lateral peripheral edges and folded upward relative to the bottom panel. First and second end portions are located at opposing longitudinal ends of the blank. Each end portion includes an inner end panel connected to a longitudinal peripheral edge of the bottom panel, an outer end panel having an inner longitudinal edge connected to an outer longitudinal edge of the inner end panel at hinge portions, first and second corner panels, each corner panel including inner longitudinal and lateral edges connected to respective edges of a side panel and the inner end panel, each corner panel folded about a diagonal gusset fold line to define a gusset, and each gusset including an edge portion defining a first locking feature for maintaining a respective gusset in a predetermined position adjacent to the inner panel, a second locking feature defined in the outer end panel for maintaining the outer end panel in a predetermined position adjacent to the gussets and the inner end panel. The outer end panel is folded about the hinge portions to overlapping relationship with at least a portion of each of the gussets to engage the first locking feature, and the second locking feature is positioned in cooperating engagement with the gussets.

The first locking feature may comprise a notch area defined on an upper edge of each gusset.

The notch area defined in the upper edge of each gusset may be engaged by a respective hinge portion.

The notch areas engaged by respective hinge portions may be located below upper edges of respective gussets, and the hinge portions may extend below an upper edge of the container defined by the outer longitudinal edge of the inner end panel.

A length dimension of each notch area, extending parallel to the upper edge of a respective gusset, may be greater than a length dimension of a respective hinge portion engaged in the notch area.

The second locking feature may comprise first and second locking tabs, each locking tab may be defined by a lateral tab separation line located longitudinally inward from an outer longitudinal edge of the outer end panel and extending laterally to define a free tab end.

The free tab ends may be positioned between a respective gusset and the inner end panel to retain the outer end panel in position over the gussets.

A longitudinal tab separation line may extend longitudinally inward from the outer longitudinal edge of the outer end panel to each of the lateral tab separation lines, wherein the free ends of the tabs may be defined at the longitudinal tab separation lines.

In accordance with a further aspect of the present disclosure, a method of forming a container from a blank is provided. The blank comprises a bottom panel having a plurality of peripheral edges, first and second side panels connected to the bottom panel at opposing lateral peripheral edges and defining lower edges of the container, first and second end portions located at opposing longitudinal ends of the blank, each end portion including an inner end panel connected to a longitudinal peripheral edge of the bottom panel, an outer end panel having an inner longitudinal edge connected to an outer longitudinal edge of the inner end panel at hinge portions. The blank further includes first and second corner panels, each corner panel having an inner longitudinal edge connected to a respective one of the first and second side panels and an inner lateral edge connected to a lateral edge of the inner end panel, and each corner panel including a notch formed in at least one of an outer longitudinal edge and an outer lateral edge of the corner panel, and first and second locking tabs are defined in the outer end panel. The method includes forming an end portion of the container comprising: folding the side panels and inner end panel upward from the bottom panel, and simultaneously folding each corner panel about a diagonal gusset fold line to define a gusset; folding each gusset perpendicular to a respective side panel to overlapping relationship with the inner end panel; folding the outer end panel about the hinge portions to engage the hinge portions in respective notch areas defined in the gussets by the notches in the corner panels; and positioning the locking tabs between a respective gusset and the inner end panel to retain the outer end panel in position over the gussets.

Engaging the hinge portions in the respective notch areas defined in the gussets may maintain each gusset in a predetermined position adjacent to the inner panel prior to positioning of the locking tabs.

A length dimension of each notch area, extending parallel to an upper edge of a respective gusset, may be greater than a length dimension of a respective hinge portion engaged in the notch area.

Folding the outer end panel about the hinge portions may comprise folding the hinge portions outward from the inner end panel to overlap the hinge portions across upper edges of respective gussets.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a plan view of a blank for forming a leak proof container;

FIG. 2 is a perspective view of an initial step in folding the blank to erect the leak proof container;

FIG. 3 is a perspective view illustrating folding of gussets over an inner end panel of the container and positioning locking tabs adjacent to edges of the gussets;

FIG. 4 is a perspective view illustrating inserting the locking tabs behind the gussets to form an end of the container;

FIG. 5 is a perspective view of the erected leak proof container;

FIG. 6 is a plan view of a blank for forming an alternative embodiment of the leak proof container;

FIG. 6A is an enlarged view of a corner panel and adjacent hinge portion of the blank of FIG. 6;

FIG. 7 is an end view of an initial step in forming an end portion of the leak proof container using the blank of FIG. 6;

FIG. 8 is a perspective view of positioning hinge portions in notch areas at upper edges of gussets during formation of the end portion of the leak proof container using the blank of FIG. 6; and

FIG. 9 is an end view of the erected leak proof container using the blank of FIG. 6.

### DETAILED DESCRIPTION OF THE INVENTION

In the following detailed description of the preferred embodiments, reference is made to the accompanying drawings that form a part hereof, and in which is shown by way of illustration, and not by way of limitation, specific preferred embodiments in which the invention may be practiced. It is to be understood that other embodiments may be utilized and that changes may be made without departing from the spirit and scope of the present invention.

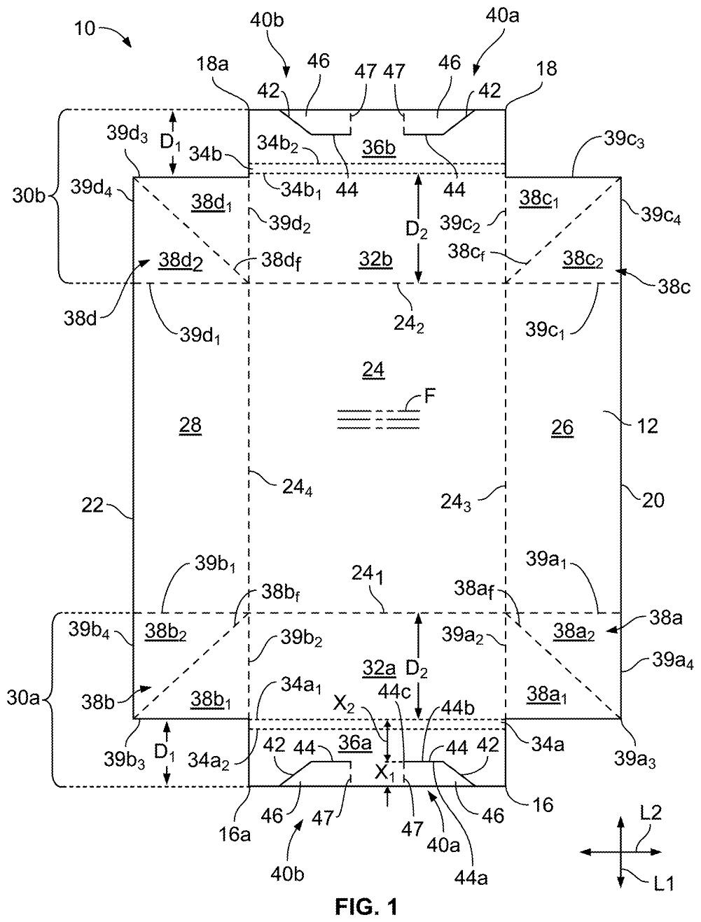

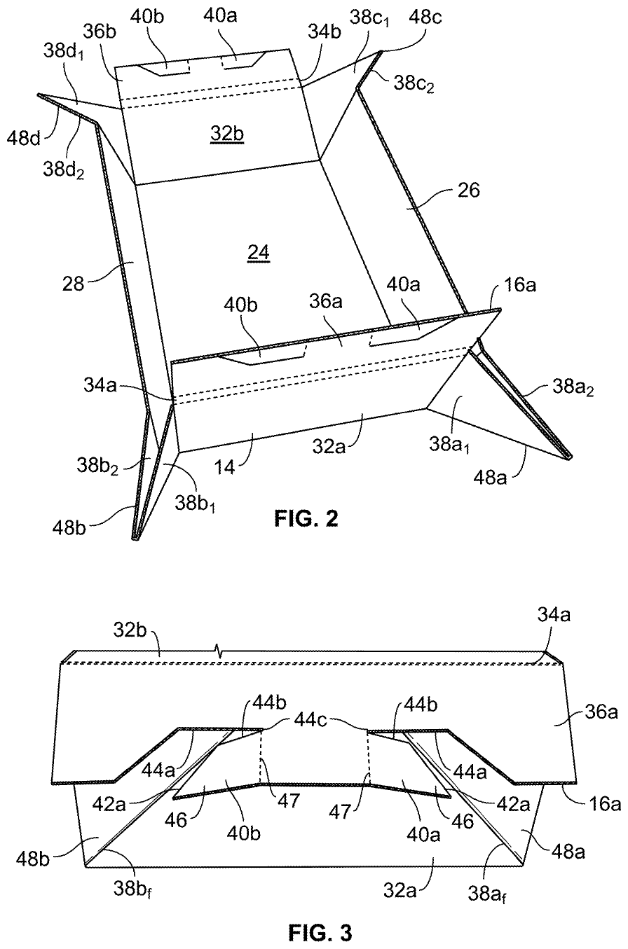

Referring to FIG. 1, a die cut blank 10 is shown for illustrating one or more aspects of a container or tray comprising a leak resistant container, as described herein. In a use of the blank 10 to form a one-piece leak proof container 8, see FIG. 5, the blank 10 may be formed of a corrugated cardboard material having an interior portion defined by elongated flutes, generally designated F in FIG. 1, as is generally known in the art, and may be die cut to the shape shown herein, although other materials and variations of the illustrated shape may be provided within the scope of the container described herein. The blank 10 illustrated in FIG. 1 is a planar piece of material in which an inner side 12 is shown facing out of the page and an outer side 14, see FIG. 2, faces in an opposite direction from the inner side 12.

As seen in FIG. 1, the blank 10 extends in a longitudinal direction L₁ between first and second longitudinal ends, generally designated 16 and 18, respectively, and further extends in a lateral direction L₂, perpendicular to the longitudinal direction L₁, between first and second lateral edges, generally designated 20 and 22, respectively. It may be noted that the flutes F extend in the lateral direction L₂.

The blank 10 comprises a bottom panel 24 having a plurality of peripheral edges 24₁, 24₂, 24₃, 24₄. A first side panel 26 is connected to the bottom panel 24 along a score line at the lateral peripheral edge 24₃, and a second side panel 28 is connected the bottom panel 24 along a score line at the opposing lateral peripheral edge 24₄. The peripheral edges 24₁, 24₂, 24₃, 24₄ define lower edges of the erected container 8.

First and second end portions 30a, 30b are located at the opposing longitudinal ends 16, 18 of the blank 10. Each end portion 30a, 30b includes a respective first and second inner end panels 32a, 32b connected to the longitudinal peripheral edges 24₁, 24₂ of the bottom panel 24 and extending between the lateral peripheral edges 24₃, 24₄. The first inner end panel 32a can include an outer longitudinal edge defined by a hinge portion 34a defined by a double score line 34a₁, 34a₂, and the second inner end panel 32b can include a hinge portion 34b defined by a double score line 34b₁, 34b₂. It should be understood that the inner end panels 32a, 32b may alternatively comprise hinge portions 34a, 34b defined by a single score line 34a₁, 34b₁.

The end portions 30a, 30b further include respective first and second outer end panels 36a, 36b. The first outer end panel 36a is hingedly joined to the first inner end panel 32a at the hinge portion 34a, and the second outer end panel 36b is hingedly joined to the second inner panel 32b at the hinge portion 34b. An inner longitudinal edge of the first outer end panel 36a can be connected to the first inner end panel 32a at the hinge portion 34a, and an outer longitudinal edge 16a of the first outer end panel 36a corresponds to the first longitudinal end 16 of the blank 10. An inner longitudinal edge of the second outer end panel 36b can be connected to the second inner end panel 32b at the hinge portion 34b, and an outer longitudinal edge 18a of the second outer end panel 36b corresponds to the second longitudinal end 18 of the blank 10. The first and second outer end panels 36a, 36b can be formed with a longitudinal dimension D₁ that is substantially less than a longitudinal dimension D₂ of the first and second inner end panels 32a, 32b.

The first end portion 30a additionally includes first and second corner panels 38a, 38b having inner longitudinal edges connected to the respective first and second side panels 26, 28 at score lines 39a₁, 39b₁ collinear with the longitudinal peripheral edge 24₁, and connected to the first inner end panel 32a at respective score lines 39a₂, 39b₂ collinear with the lateral peripheral edges 24₃, 24₄. The first and second corner panels 38a, 38b can each be formed with a square configuration having respective outer longitudinal edges 39a₃, 39b₃ collinear, or generally collinear with the outer longitudinal edge of the first inner end panel 32a, e.g., at the score line 34a₁, and having outer lateral edges 39a₄, 39b₄ collinear with the first and second lateral edges 20, 22, respectively. The first corner panel 38a additionally includes a score line defining a respective gusset fold line 38a_{f} extending diagonally across the corner panel 38a from an inner corner defined at an intersection of the score lines 39a₁ and 39a₂ to an intersection of the outer longitudinal edge 39a₃ and outer lateral edge 39a₄. Similarly, the second corner panel 38b additionally includes a score line defining a respective gusset fold line 38b_{f} extending diagonally across the corner panel 38b from an inner corner defined at an intersection of the score lines 39b₁ and 39b₂ to an intersection of the outer longitudinal edge 39b₃ and outer lateral edge 39b₄ The diagonal fold lines 38a_{f}, 38b_{f} divide the first and second corner panels 38a, 38b into first and second triangular gusset panels 38a₁, 38a₂ and 38b₁, 38b₂, respectively.

The second end portion 30b additionally includes first and second corner panels 38c, 38d having inner longitudinal edges connected to the respective first and second side panels 26, 28 at score lines 39c₁, 39d₁ collinear with the longitudinal peripheral edge 24₂, and connected to the first inner end panel 32b at respective score lines 39c₂, 39d₂ collinear with the lateral peripheral edges 24₃, 24₄. The first and second corner panels 38c, 38d can each be formed with a square configuration having respective outer longitudinal edges 39c₃, 39d₃ collinear, or generally collinear with the outer longitudinal edge of the second inner end panel 32b, e.g., at the score line 34b₁, and having outer lateral edges 39c₄, 39d₄ collinear with the first and second lateral edges 20, 22, respectively. The first corner panel 38c additionally includes a score line defining a respective gusset fold line 38c_{f} extending diagonally across the corner panel 38c from an inner corner defined at an intersection of the score lines 39c₁ and 39c₂ to an intersection of the outer longitudinal edge 39c₃ and outer lateral edge 39c₄. Similarly, the second corner panel 38d additionally includes a score line defining a respective gusset fold line 38d_{f} extending diagonally across the corner panel 38d from an inner corner defined at an intersection of the score lines 39d₁ and 39d₂ to an intersection of the outer longitudinal edge 39d₃ and outer lateral edge 39d₄ The diagonal fold lines 38c_{f}, 38d_{f} divide the first and second corner panels 38c, 38d into first and second triangular gusset panels 38c₁, 38c₂ and 38d₁, 38d₂, respectively.

The first outer end panel 36a includes a pair of laterally spaced tabs or tab structures 40a, 40b extending inward from the outer longitudinal edge 16a of the outer end panel 36a to form a push lock body for the first outer end panel 36a. Similarly, the second outer end panel 36b includes a pair of laterally spaced tab structures 40a, 40b extending inward from the outer longitudinal edge 18a of the outer end panel 36b to form a push lock body for the second outer end panel 36b.

Each tab structure 40a, 40b defines a locking tab and is defined by a longitudinal separation line 42 extending longitudinally inward from a respective outer longitudinal edge 16a, 18a, and a lateral separation line 44 located longitudinally inward from the respective longitudinal edge 16a, 18a and intersecting the longitudinal separation line 42 at a free end 46 of the tabs 40a, 40b, wherein laterally outer edges 42a of the tab ends 46 are defined at the longitudinal separation lines 42. The lateral separation lines 44 are spaced from the outer longitudinal edge 16a, 18a of a respective outer end panel 36a, 36b a distance X₁ that is less than a distance X₂ from the lateral separation lines 42 to the respective inner longitudinal ends, e.g., at the hinge portions 34a, 34b, of the outer end panel 36a, 36b. The longitudinal separation lines 42 on each outer end panel 36a, 36b angle laterally inward toward each other extending from the outer longitudinal edge 16a, 18a of the outer end panel 36a, 36b toward a respective lateral separation line 44. Further, a hinge connection is defined at a score line 47 between each tab structure 40a, 40b and a respective outer end panel 36a, 36b.

As is exemplified in FIG. 1 by the tab structure 40a on the outer end panel 36a, each lateral separation line 44 is defined by a first, panel edge 44a and a second, tab edge 44b extending to an inner end 44c of the lateral separation line 44, wherein the panel edge 44a and the tab edge 44b are colinear to the lateral separation line 44, such as may be defined by a straight common knife cut or area. The longitudinal separation line 42 and the lateral separation line 44 can be defined by cut lines, e.g., clean cut lines, that extend completely through the outer end panel 36a, 36b. However, it may be understood that the separation lines 42, 44 may also be defined by perforations that extend completely or partially through the outer end panels 36a, 36b.

Referring to FIGS. 2-5 a method of forming the blank 10 into an erected container 8 is described. The side panels 26, 28 and inner end panels 32a, 32b are initially folded upward from the bottom panel 24. Simultaneously, the corner panels 38a, 38b, 38c, 38d can be folded about respective gusset fold lines 38a_{f}, 38b_{f}, 38c_{f}, 38d_{f} to define gussets 48a, 48b, 48c, 48d. Subsequently, the gussets 48a, 48b, 48c, 48d can be folded perpendicular to a respective side panel 26, 28 into overlapping relationship with an inner end panel 32a, 32b, as illustrated by gussets 48a, 48b in overlapping relationship with the inner end panel 32a in FIG. 3. The configuration formed by the folded gussets 48a, 48b, 48c, 48d defines folded container corners that form a continuous connection between the side panels 26, 28 and the inner end panels 32a, 32b extending from the bottom panel 24 to an upper edge 50, see FIG. 5, of the container 8. Hence, the continuous configuration formed by the gussets 48a, 48b, 48c, 48d can prevent or substantially limit fluids from leaking out of the container 8 at junctions between the side panels 26, 28 and the inner end panels 32a, 32b.

In the position depicted in FIG. 3, the outer end panel 36a is pivoted about the inner longitudinal edge, i.e., at the hinge portion 34a, to a position outwardly spaced from the inner end panel 32a. The tab structures 40a, 40b are pivoted about the score lines 47 to locate the edges 42a of the tab ends 46 adjacent to the inner end panel 32a near the gusset fold lines 38a_{f}, 38b_{f} in preparation for positioning the tab ends 46 between the inner end panel 32a and the gussets 48a, 48b. It may be noted that the angled configuration of the edges 42a generally conforms to the angle of the gusset fold lines 38a_{f}, 38b_{f} which can minimize the pivoting of the tabs 40a, 40b at the score lines 47 as the edges 42a are located near the gusset fold lines 38a_{f}, 38b_{f}.

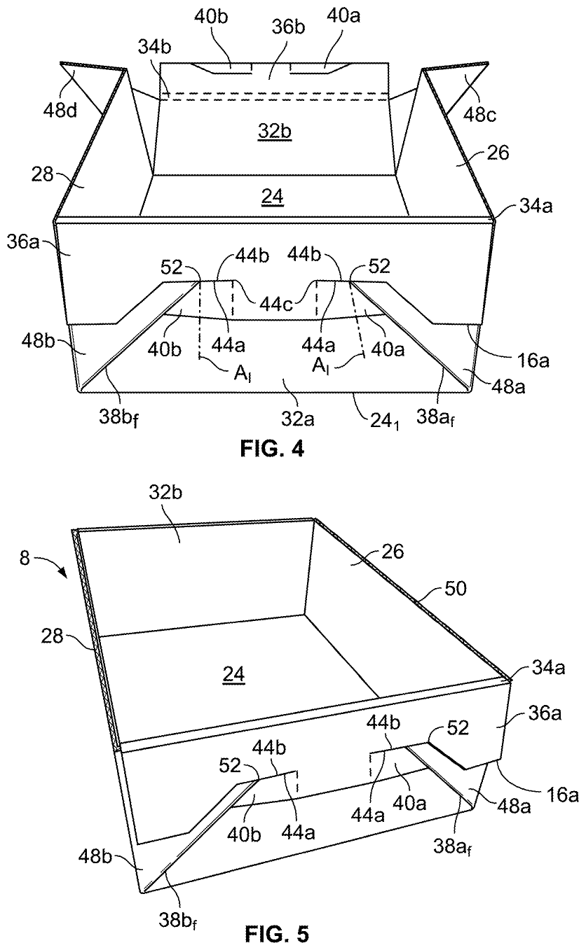

As seen in FIG. 4, the outer end panel 36a and tabs 40a, 40b can be pushed inward toward the inner end panel 32a to insert the tab ends 46 of the tabs 40a, 40b between the inner end panel 32a and the gussets 48a, 48b, defining an inserted position of the tabs 40a, 40b. In the inserted tab position, the gusset fold lines 38a_{f}, 38b_{f} intersect the respective adjacent panel edges 44a and tab edges 44b at a common intersection point 52, i.e. along a common intersection axis A_{I}. Each intersection point 52 defines a close fit between the gusset fold lines 38a_{f}, 38b_{f} and respective adjacent panel edges 44a and tab edges 44b, forming a tight locking structure for retaining the outer end panel 36a in close overlapping relation over the inner end panel 32a, as well as to retain the gussets 48a, 48b in their folded positions overlapping the inner end panel 32a.

It may be noted that the outer longitudinal edges 16a, 16b of the outer end panels 36a, 36b may be located in vertically spaced relation from the bottom 24 of the container, i.e., the peripheral edges 24₁, 24₂. For example, the outer end panels 36a, 36b may extend approximately half-way down the inner end panels 32a, 32b to reduce the material required for the outer end panel material while providing sufficient structure to the tabs 40a, 40b to form a relatively rigid locking structure for retaining the outer end panels 36a, 36b and gussets 48a, 48b, 48c, 48d in their folded position.

The inner end panel 32b, outer end panel 36b, and gussets 48c, 48d forming the opposing end of the container 8 can be folded in manner similar to that described above for the inner end panel 32a, outer end panel 36a, and gussets 48a, 48b to form the completed container 8, as illustrated in FIG. 5. The described container provides a configuration that can be readily assembled manually, with positively locking tab structures 40a, 40b that are conveniently manipulated to provide a securely constructed container. Also, it should be noted that, although the described construction of the container presents the gussets 48a, 48b, 48c, 48d being folded outward of the container, the gussets 48a, 48b, 48c, 40d may alternatively be folded inward to overlap respective inner sides of the inner end panels 32a, 32b and the outer end panels 36a, 36b may be folded inward to place the locking tab structures 40a, 40b on the inner side of the container.

It may be understood that, by forming the tabs 40a, 40b with the described separation lines 42, 44, without additional features such as cutouts or slots, the potential for debris created from such cutouts or slots is avoided. Specifically, the blank and associated container described herein can reduce the potential for trim debris within the blank area by providing a clean outside perimeter, with straight cuts, including straight common knife areas, and no internal trim areas, such as are described for the separation lines 42, 44. Hence, the configuration of the blank 10 and resulting container 8 can provide a container for food products that can avoid or substantially reduce contamination as a result of eliminating internal scrap areas, for example, eliminating the release of debris from the blank structure and/or when scrap is released but falls in between plural containers as they are stacked or otherwise grouped together.

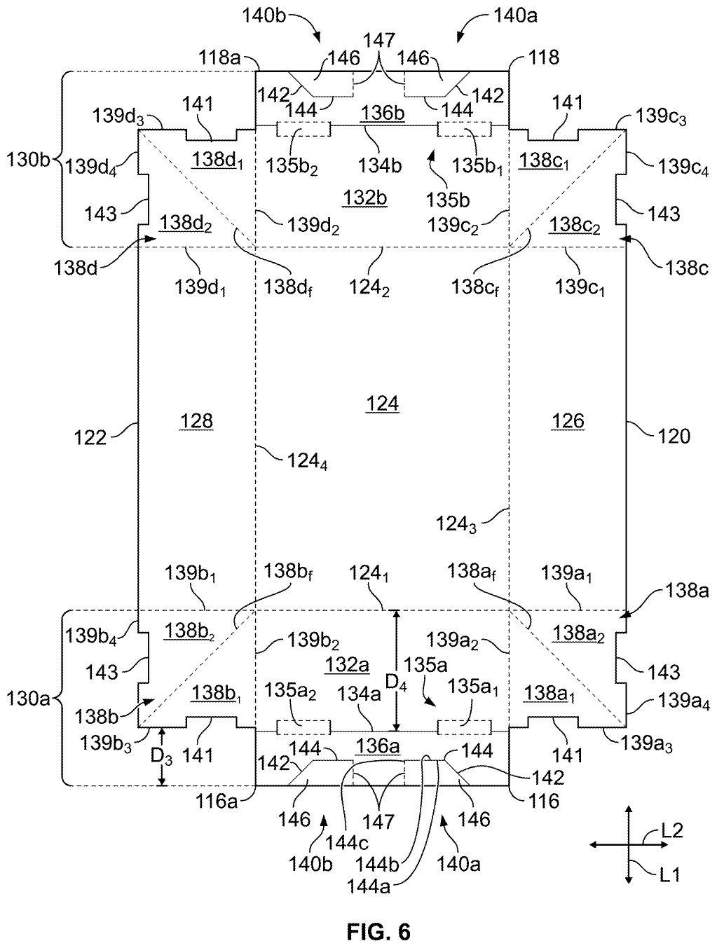

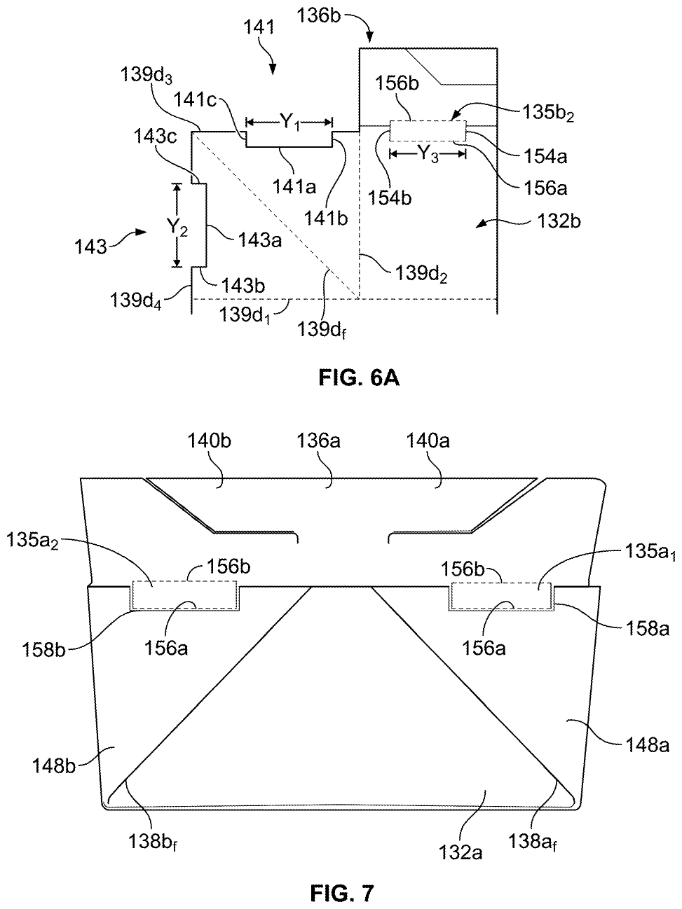

Referring to FIGS. 6-9, an alternative embodiment of a container 108 is illustrated wherein elements corresponding to elements of the container 8 described above with reference to FIGS. 1-5 are labeled with the same reference numeral increased by 100.

Referring initially to FIG. 6, a blank 110 for forming the container 108 comprises a bottom panel 124 having a plurality of peripheral edges 124₁, 124₂, 124₃, 124₄. A first side panel 126 is connected to the bottom panel 124 along a score line at the lateral peripheral edge 124₃, and a second side panel 128 is connected to the bottom panel 124 along a score line at the opposing lateral peripheral edge 124₄. The peripheral edges 124₁, 124₂, 124₃, 124₄ define lower edges of the erected container 108.

First and second end portions 130a, 130b are located at the opposing longitudinal ends 116, 118 of the blank 110. Each end portion 130a, 130b includes a respective first and second inner end panel 132a, 132b connected to the longitudinal peripheral edges 124₁, 124₂ of the bottom panel 124 and extending between the lateral peripheral edges 124₃, 124₄. The first inner end panel 132a can include an outer longitudinal edge defined by a separation line 134a, and the second inner end panel 132b can include can include an outer longitudinal edge defined by a separation line 134b. The separation lines 134a, 134b may comprise clean cut lines providing a line of separation between the inner end panels 132a, 132b and the respective outer end panels 136a, 136b.

The end portions 130a, 130b further include respective first and second outer end panels 136a, 136b. The first outer end panel 136a is hingedly joined to the first inner end panel 132a at integral hinge portions 135a that can comprise first and second laterally spaced hinge portions 135a₁, 135a₂, and the second outer end panel 136b is hingedly joined to the second inner panel 132b at integral hinge portions 135b that can comprise first and second laterally spaced hinge portions 135b₁, 135b₂. A first or inner longitudinal edge of the first outer end panel 136a is defined at the separation line 134a, wherein the hinge portions 135a are longitudinally aligned with and extend across the separation line 134a to connect the first outer end panel 136a to the first inner end panel 132a, and a second or outer longitudinal edge 116a of the first outer end panel 136a corresponds to the first longitudinal end 116 of the blank 110. A first or inner longitudinal edge of the second outer end panel 136b is defined at the separation line 134b, wherein the hinge portions 135b are longitudinally aligned with and extend across the separation line 134b to connect the second outer end panel 136b to the second inner end panel 132b, and a second or outer longitudinal edge 118a of the second outer end panel 136b corresponds to the second longitudinal end 118 of the blank 110. The first and second outer end panels 136a, 136b can be formed with a longitudinal dimension D₃ that is substantially less than a longitudinal dimension D₄ of the first and second inner end panels 132a, 132b.

The first end portion 130a additionally includes first and second corner panels 138a, 138b having inner longitudinal edges connected to the respective first and second side panels 126, 128 at score lines 139a₁, 139b₁ collinear with the longitudinal peripheral edge 124₁, and having inner lateral edges connected to the first inner end panel 132a at respective score lines 139a₂, 139b₂ collinear with the lateral peripheral edges 124₃, 124₄. The first and second corner panels 138a, 138b can each be formed with a square configuration having respective outer longitudinal edges 139a₃, 139b₃ collinear, or generally collinear with the outer longitudinal edge of the first inner end panel 132a, e.g., at the separation line 134a, and having outer lateral edges 139a₄, 139b₄ collinear with the first and second lateral edges 120, 122, respectively. The first corner panel 138a additionally includes a score line defining a respective gusset fold line 138a_{f} extending diagonally across the corner panel 138a from an inner corner defined at an intersection of the score lines 139a₁ and 139a₂ to an intersection of the outer longitudinal edge 139a₃ and outer lateral edge 139a₄. Similarly, the second corner panel 138b additionally includes a score line defining a respective gusset fold line 138b_{f} extending diagonally across the corner panel 138b from an inner corner defined at an intersection of the score lines 139b₁ and 139b₂ to an intersection of the outer longitudinal edge 139b₃ and outer lateral edge 139b₄. The diagonal fold lines 138a_{f}, 138b_{f} divide the first and second corner panels 138a, 138b into first and second triangular gusset panels 138a₁, 138a₂ and 138b₁, 138b₂, respectively.

The second end portion 130b additionally includes first and second corner panels 138c, 138d having inner longitudinal edges connected to the respective first and second side panels 126, 128 at score lines 139c₁, 139d₁ collinear with the longitudinal peripheral edge 124₂, and having inner lateral edges connected to the second inner end panel 132b at respective score lines 139c₂, 139d₂ collinear with the lateral peripheral edges 124₃, 124₄. The first and second corner panels 138c, 138d can each be formed with a square configuration having respective outer longitudinal edges 139c₃, 139d₃ collinear, or generally collinear with the outer longitudinal edge of the second inner end panel 132b, e.g., at the separation line 134b, and having outer lateral edges 139c₄, 139d₄ collinear with the first and second lateral edges 120, 122, respectively. The first corner panel 138c additionally includes a score line defining a respective gusset fold line 138c_{f} extending diagonally across the corner panel 138c from an inner corner defined at an intersection of the score lines 139c₁ and 139c₂ to an intersection of the outer longitudinal edge 139c₃ and outer lateral edge 139c₄. Similarly, the second corner panel 138d additionally includes a score line defining a respective gusset fold line 138d_{f} extending diagonally across the corner panel 138d from an inner corner defined at an intersection of the score lines 139d₁ and 139d₂ to an intersection of the outer longitudinal edge 139d₃ and outer lateral edge 139d₄ The diagonal fold lines 138c_{f}, 138d_{f} divide the first and second corner panels 138c, 138d into first and second triangular gusset panels 138c₁, 138c₂ and 138d₁, 138d₂, respectively.

Further, each of the corner panels 138a, 138b, 138c, 138d can include a pair of notches. As seen in FIG. 6, the pair of notches can comprise a longitudinal notch 141 located extending along a respective outer longitudinal edge 139a₃, 139b₃, 139c₃, 139d₃, and a lateral notch 143 extending along a respective outer lateral edge 139a₄, 139b₄, 139c₄, 139d₄.

Referring further to FIG. 6A, an enlarged view of the corner panel 138d and adjacent hinge portion 135b₂ is shown, which is typical of, or generally identical to, the remaining corner panels 138a, 138b, 138c and respective hinge portions 135a₁, 135a₂, 135b₁. The notches 141, 143 are configured the same or substantially the same, and each notch 141, 143 includes a respective inner edge 141a, 143a, and side edges 141b, 141c and 143b, 143c extending perpendicular to the respective inner edge 141a, 143a.

Additionally, the hinge portion 135b₂ is defined between a pair of laterally spaced hinge separation lines 154a, 154b, e.g., clean cut lines, that span across the separation line 134b. The hinge 135b₂ is further defined between laterally extending score lines 156a, 156b that extend between ends of the separation lines 154a, 154b, and that form hinge locations for hingedly supporting the second outer end panel 136b to the second inner end panel 132b.

The longitudinal notch 141 defines a longitudinal notch dimension Y₁, i.e., a length dimension extending between the side edges 141b, 141c, and the lateral notch 143 defines a lateral notch dimension Y₂, i.e., a length dimension extending between the side edges 143b, 143c, that is equal to, or substantially equal to, the longitudinal notch dimension Y₁. The hinge portion 135b₂ defines a lateral hinge dimension Y₃, i.e., a length dimension extending between the cut lines 154a, 154b, wherein the lateral hinge dimension Y₃ is preferably less than the longitudinal notch dimension Y₁ and the lateral notch dimension Y₂. In a non-limiting exemplary embodiment, the lateral hinge dimension Y₃ may be 2.25 inches and the longitudinal and lateral notch dimensions Y₁, Y₂ may each be 2.5 inches, such that the lateral hinge dimension Y₃ may be approximately 10% less than the longitudinal and lateral notch dimensions Y₁, Y₂.

It should be understood that, although the notches 141, 143 are described as being defined between respective side edges, 141b, 141c and 143b, 143c, in some embodiments the notches 141, 143 may include an open side, such as may be defined, for example, by a notch 141, 143 that has a side edge aligned with a score line 139a₁, 139a₂, 139b₁, 139b₂, 139c₁, 139c₂, 139d₁, 139d₂ defining a side edge of the corner panel 138a, 138b, 138c, 138d.

Referring to FIG. 6, The first outer end panel 136a includes a pair of laterally spaced tabs or tab structures 140a, 140b formed integral with the outer end panel 136a and extending inward from the outer longitudinal edge 116a of the outer end panel 136a to form a push lock body for the first outer end panel 136a. Similarly, the second outer end panel 136b includes a pair of laterally spaced tab structures 140a, 140b formed integral with the outer end panel 136b and extending inward from the outer longitudinal edge 118a of the second outer end panel 136b to form a push lock body for the second outer end panel 136b.

Each tab structure 140a, 140b defines a locking tab and is defined by a longitudinal separation line 142 extending longitudinally inward from a respective outer longitudinal edge 116a, 118a, and a lateral separation line 144 located longitudinally inward from the respective longitudinal edge 116a, 118a and intersecting the longitudinal separation line 142 at a free end 146 of the tabs 140a, 140b, wherein laterally outer edges of the tab ends 146 are defined at the longitudinal separation lines 142. The longitudinal separation lines 142 on each outer end panel 136a, 136b angle laterally inward toward each other extending from the outer longitudinal edge 116a, 118a of the outer end panel 136a, 136b toward a respective lateral separation line 144. Further, a hinge connection is defined at a score line 147 between each tab structure 140a, 140b and a respective outer end panel 136a, 136b.

As is exemplified in FIG. 6 by the tab structure 140a on the outer end panel 136a, each lateral separation line 144 is defined by a first, panel edge 144a and a second, tab edge 144b extending to an inner end 144c of the lateral separation line 144, wherein the panel edge 144a and the tab edge 144b are collinear to the lateral separation line 144, such as may be defined by a straight common knife cut or area. The longitudinal separation line 142 and the lateral separation line 144 can be defined by cut lines, e.g., clean cut lines, that extend completely through the outer end panel 136a, 136b. However, it may be understood that the separation lines 142, 144 may also be defined by perforations that extend completely or partially through the outer end panels 136a, 136b.

Referring to FIGS. 7-9, a method of forming the blank 110 into an erected container 108 is described. The side panels 126, 128 and inner end panels 132a, 132b are initially folded upward from the bottom panel 24. Simultaneously, the corner panels 138a, 138b, 138c, 138d can be folded about respective gusset fold lines 138a_{f}, 138b_{f}, 138c_{f}, 138d_{f} to define additional end panels comprising gussets 148a, 148b, 148c, 148d. Subsequently, the gussets 148a, 148b, 148c, 148d can be folded or pivoted transverse to, e.g., perpendicular to, a respective side panel 126, 128 into overlapping relationship with an inner end panel 132a, 132b, as illustrated by gussets 148a, 148b in overlapping relationship with the inner end panel 132a in FIG. 7. The configuration formed by the folded gussets 148a, 148b, 148c, 148d defines folded container corners that form a continuous connection between the side panels 126, 128 and the inner end panels 132a, 132b extending from the bottom panel 124 to an upper edge 150 of the container 108. Hence, the continuous configuration formed by the gussets 148a, 148b, 148c, 148d can prevent or substantially limit fluids from leaking out of the container 108 at junctions between the side panels 126, 128 and the inner end panels 132a, 132b.

In the position depicted in FIG. 7, the hinge portions 135a₁, 135a₂ are aligned with respective notch areas 158a, 158b formed in the gussets 148a, 148b. It may be noted that the notch areas 158a, 158b are formed in the upper edges of the gussets 148a, 148b by alignment of the respective longitudinal and lateral notch portions 141, 143 with one another as the corner panels 138a, 138b are folded.

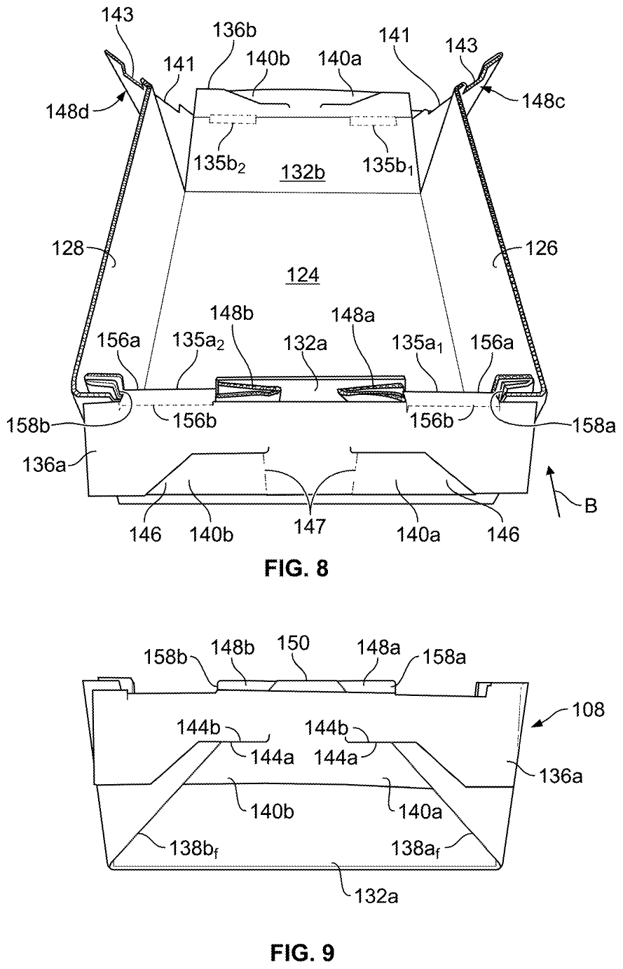

As can be seen in FIG. 8, the first outer end panel 136a can be pivoted about the hinge portions 135a₁, 135a₂ to a position outwardly spaced from the inner end panel 132a. In particular, the hinge portions 135a₁, 135a₂ are pivoted across, or rolled over, the upper edges of the gussets 148a, 148b and positioned within the notch areas 158a, 158b. In the position illustrated in FIG. 8, the hinge portions 135a₁, 135a₂ and first outer end panel 136a can engage the upper edges of the gussets 148a, 148b to retain the gussets 148a, 148b in position closely adjacent to the first inner end panel 132a. Subsequently, the tab structures 140a, 140b can be manipulated to position the tab ends 146 of the tabs 140a, 140b between the inner end panel 132a and the gussets 148a, 148b, defining an inserted position of the tabs 140a, 140b, substantially as described above for the embodiment of FIGS. 1-5.

The inner end panel 132b, outer end panel 136b, and gussets 148c, 148d forming the opposing end of the container 108 can be folded in manner similar to that described above for the inner end panel 132a, outer end panel 136a, and gussets 148a, 148b to form the completed container 108, as illustrated in FIG. 9. The described container provides a configuration that can be readily assembled manually, with positively locking tab structures 140a, 140b that are conveniently manipulated to provide a securely constructed container. Further, the hinge portions 135a₁, 135a₂, 135b₁, 135b₂ engaged within respective notch areas 158a, 158b can define a first locking feature that is located at the first longitudinal edge of the outer end panel 136a, 136b that facilitates assembly of the container 108 by freeing an operator from having to hold the gussets 148a, 148b, 148c, 148d in position during insertion of the tab structures 140a, 140b, forming a second locking feature that is located at the second longitudinal edge of the outer end panel 136a, 136b and that is configured differently from the first locking feature.

It may be seen that the hinge portions 135a₁, 135a₂, 135b₁, 135b₂ engaged within the notch areas 158a, 158b provides a locking structure that can further maintain secure assembly of the container 108 in combination with the engagement of the tab structures 140a, 140b positioned behind the gussets 148a, 148b, 148c, 148d. In particular, the first locking feature, i.e., formed by the hinge portions 135a₁, 135a₂, 135b₁, 135b₂ engaged within respective notch areas 158a, 158b, can apply a force to the gussets 148a, 148b, 148c, 148d in a first direction, see FIG. 8 illustrating a first direction B relative to gussets 148a, 148b, to maintain the gussets 148a, 148b, 148c, 148d in a position oriented transverse to the side panels 126, 128, and the second locking feature, i.e., the tab structures 140a, 140b positioned behind the gussets 148a, 148b, 148c, 148d, applies a force to the outer end panels 136a, 136b to resist movement of the outer end panels 136a, 136b in a direction opposite to the first direction B.

Also, providing the notch areas 158a, 158b with a length dimension, as defined by the length dimensions Y₁, Y₂ of the notches 141, 143 parallel the upper edges of the gussets 148a, 148b, 148c, 148d, and greater than the length dimension of the hinge portions 135a₁, 135a₂, 135b₁, 135b₂, can enable the hinge portions 135a₁, 135a₂, 135b₁, 135b₂ to easily slip into the notch areas 158a, 158b without binding or interference during assembly of the container 108, without adversely affecting the locking function performed by the hinge portions 135a₁, 135a₂, 135b₁, 135b₂ and notch areas 158a, 158b.

As with the embodiment of FIGS. 1-5, it may be understood that, by forming the tabs 140a, 140b with the described separation lines 142, 144, without additional features such as cutouts or slots, the potential for debris created from such cutouts or slots is avoided. Specifically, the blank and associated container described herein can reduce the potential for trim debris within the blank area by providing a clean outside perimeter, including straight cuts to define the notch portions 141, 143, and no internal trim areas, such as are described for the separation lines 142, 144. Hence, the configuration of the blank 110 and resulting container 108 can provide a container for food products that can avoid or substantially reduce contamination as a result of eliminating internal scrap areas, for example, eliminating the release of debris from the blank structure and/or when scrap is released but falls in between plural containers as they are stacked or otherwise grouped together.

The configuration of the blank 110 and resulting container 108 is believed to also enable a reduction in material, e.g., in comparison to the blank 10 and associated container 8 described above, in that the locking feature provided by the hinge portions 135a₁, 135a₂, 135b₁, 135b₂ and associated notch areas 158a, 158b can provide additional stability to the ends of the container 108, allowing a reduction in the longitudinal length of the outer end panels 136a, 136b, i.e., longitudinal dimension D₃, while maintaining a secure assembly of the container 108.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A blank for making a leak proof container comprising:
a bottom panel having a plurality of peripheral edges;
first and second side panels connected to the bottom panel at opposing lateral peripheral edges and defining lower edges of the container;
first and second end portions located at opposing longitudinal ends of the blank, each end portion including:
an inner end panel connected to a longitudinal peripheral edge of the bottom panel;
an outer end panel having an inner longitudinal edge connected to a longitudinal edge of the inner end panel at hinge portions;
first and second corner panels, each corner panel having an inner longitudinal edge connected to a respective one of the first and second side panels and an inner lateral edge connected to a lateral edge of the inner end panel, and each corner panel including a notch formed in at least one of an outer longitudinal edge and an outer lateral edge of the corner panel; and
first and second locking tabs defined in the outer end panel, each locking tab defined by a lateral tab separation line located longitudinally inward from an outer longitudinal edge of the outer end panel and extending laterally to define a free tab end.

2. The blank as set forth in claim 1, wherein the hinge portions comprise laterally spaced first and second hinge portions, each hinge portion defined by a pair of longitudinally spaced hinge score lines and a pair of laterally spaced hinge separation lines extending longitudinally between the pair of longitudinally spaced hinge score lines.

3. The blank as set forth in claim 2, wherein each corner panel includes a pair of notches comprising a longitudinal notch and a lateral notch extending along the outer longitudinal edge and the outer lateral edge, respectively, of the corner panel.

4. The blank as set forth in claim 3, wherein the longitudinal and lateral notches define respective longitudinal and lateral notch dimensions, and the longitudinal and lateral notch dimensions are greater than a lateral dimension of the hinge portions, measured between the laterally spaced hinge separation lines.

5. The blank as set forth in claim 2, including a separation line longitudinally aligned with the first and second hinge portions and defining a boundary between the inner and outer end panels.

6. The blank as set forth in claim 1, wherein the corner panels are formed as square panels, and including a diagonal fold line dividing each corner panel into first and second triangular gusset panels.

7. The blank as set forth in claim 6, wherein the outer lateral edge of each corner panel is colinear with a lateral edge of the blank defined by an edge of one of the first and second side panels.

8. The blank as set forth in claim 1, including a longitudinal tab separation line extending longitudinally inward from the outer longitudinal edge of the outer end panel to each of the lateral tab separation lines, wherein the longitudinal tab separation lines angle laterally inward toward each other extending from the outer longitudinal edge of the outer end panel toward a respective lateral tab separation line, and the free ends of the tabs are defined at the longitudinal tab separation lines.

9. The blank as set forth in claim 1, wherein a longitudinal dimension of the outer end panel is substantially less than a longitudinal dimension of the inner end panel.

10. A container including a bottom panel and a plurality of side panels, and a plurality of overlapping end panels defining at least one end portion, the at least one end portion comprising:
a first locking feature formed integral with at least one end panel and engaged with an additional end panel positioned in overlapping relationship with the at least one end panel to at least partially lock one or more of the end panels in an assembled position at the end portion; and
a second locking feature formed integral with the at least one end panel and configured differently from the first locking feature, wherein the second locking feature is engaged with the additional end panel to at least partially lock one or more of the end panels in an assembled position at the end portion.

11. The container as set forth in claim 10, wherein at least a portion of the first locking feature is located adjacent to a first longitudinal edge of the at least one end panel, and at least a portion of the second locking feature is located adjacent to a second longitudinal edge of the at least one end panel, opposite from the first longitudinal edge.

12. The container as set forth in claim 10, wherein the first locking feature applies a force to the additional end panel in a first direction to maintain the additional end panel in a position oriented transverse to at least one side panel, and the second locking feature applies a force to the at least one end panel to resist movement of the at least one end panel in a direction opposite to the first direction.

13. The container as set forth in claim 12, wherein the plurality of end panels comprises an inner end panel connected to the bottom panel and an outer end panel connected to the inner end panel and positioned in overlapping relation to the inner end panel.

14. The container as set forth in claim 13, wherein the first locking feature comprises a hinge portion connecting the outer end panel to the inner end panel, and the hinge portion engages a notch area formed in an edge of the additional end panel.

15. The container as set forth in claim 14, wherein the second locking feature comprises a locking tab positioned between the additional end panel and the inner end panel.

16. The container as set forth in claim 15, wherein the additional end panel comprises a gusset connected to a side panel and positioned between the outer end panel and the inner end panel.

17. A container including a bottom panel defining a bottom of the container and having a plurality of peripheral edges, first and second side panels connected to the bottom panel at opposing lateral peripheral edges and folded upward relative to the bottom panel, first and second end portions located at opposing longitudinal ends of the blank, each end portion including:
an inner end panel connected to a longitudinal peripheral edge of the bottom panel;
an outer end panel having an inner longitudinal edge connected to an outer longitudinal edge of the inner end panel at hinge portions;
first and second corner panels, each corner panel including inner longitudinal and lateral edges connected to respective edges of a side panel and the inner end panel, each corner panel folded about a diagonal gusset fold line to define a gusset, and each gusset including an edge portion defining a first locking feature for maintaining a respective gusset in a predetermined position adjacent to the inner panel;
a second locking feature defined in the outer end panel for maintaining the outer end panel in a predetermined position adjacent to the gussets and the inner end panel; and
wherein the outer end panel is folded about the hinge portions to overlapping relationship with at least a portion of each of the gussets to engage the first locking feature, and the second locking feature is positioned in cooperating engagement with the gussets.

18. The container as set forth in claim 17, wherein the first locking feature comprises a notch area defined on an upper edge of each gusset.

19. The container as set forth in claim 18, wherein the notch area defined in the upper edge of each gusset is engaged by a respective hinge portion.

20. The container as set forth in claim 19, wherein the notch areas engaged by respective hinge portions are located below upper edges of respective gussets, and the hinge portions extend below an upper edge of the container defined by the outer longitudinal edge of the inner end panel.

21. The container as set forth in claim 19, wherein a length dimension of each notch area, extending parallel to the upper edge of a respective gusset, is greater than a length dimension of a respective hinge portion engaged in the notch area.

22. The container as set forth in claim 17, wherein the second locking feature comprises first and second locking tabs, each locking tab defined by a lateral tab separation line located longitudinally inward from an outer longitudinal edge of the outer end panel and extending laterally to define a free tab end.

23. The container as set forth in claim 22, wherein the free tab ends are positioned between a respective gusset and the inner end panel to retain the outer end panel in position over the gussets.

24. The container as set forth in claim 22, including a longitudinal tab separation line extending longitudinally inward from the outer longitudinal edge of the outer end panel to each of the lateral tab separation lines, wherein the free ends of the tabs are defined at the longitudinal tab separation lines.

25. A method of forming a container from a blank comprising a bottom panel having a plurality of peripheral edges, first and second side panels connected to the bottom panel at opposing lateral peripheral edges and defining lower edges of the container, first and second end portions located at opposing longitudinal ends of the blank, each end portion including an inner end panel connected to a longitudinal peripheral edge of the bottom panel, an outer end panel having an inner longitudinal edge connected to an outer longitudinal edge of the inner end panel at hinge portions, first and second corner panels, each corner panel having an inner longitudinal edge connected to a respective one of the first and second side panels and an inner lateral edge connected to a lateral edge of the inner end panel, and each corner panel including a notch formed in at least one of an outer longitudinal edge and an outer lateral edge of the corner panel, and first and second locking tabs defined in the outer end panel, the method including forming an end portion of the container comprising:
folding the side panels and inner end panel upward from the bottom panel, and simultaneously folding each corner panel about a diagonal gusset fold line to define a gusset;
folding each gusset perpendicular to a respective side panel to overlapping relationship with the inner end panel;
folding the outer end panel about the hinge portions to engage the hinge portions in respective notch areas defined in the gussets by the notches in the corner panels; and
positioning the locking tabs between a respective gusset and the inner end panel to retain the outer end panel in position over the gussets.

26. The method of forming a container as set forth in claim 25, wherein engaging the hinge portions in the respective notch areas defined in the gussets maintains each gusset in a predetermined position adjacent to the inner panel prior to positioning of the locking tabs.

27. The method of forming a container as set forth in claim 25, wherein a length dimension of each notch area, extending parallel to an upper edge of a respective gusset, is greater than a length dimension of a respective hinge portion engaged in the notch area.

28. The method of forming a container as set forth in claim 25, wherein folding the outer end panel about the hinge portions comprises folding the hinge portions outward from the inner end panel to overlap the hinge portions across upper edges of respective gussets.
